(19) United States
(12) Patent Application Publication
(10) Pub. No.: US 2004/0220850 A1
(43) Pub. Date: Nov. 4, 2004

(54) Method of viral marketing using the internet

(76) Inventors: Miguel Ferrer, New York, NY (US); Sophy Regelous, New York, NY (US)

Correspondence Address: PATENT LAW OFFICES OF HEATH W. HOGLUND, 256 ELEANOR ROOSEVELT STREET, SAN JUAN, PR, 00918, US

(21) Appl. No.: 10/226,223

(22) Filed: Aug. 23, 2002

(51) Int. Cl. G06F 17/60

(52) U.S. Cl. 705/14

(57) ABSTRACT

A method for facilitating viral marketing is disclosed in which a plurality of computer users communicate via a set of interconnected terminals and share online experiences under the direction of a single user. A plurality of terminals, each having a user interface, connect to a server or network through a portal rather than directly to the server. One terminal serves as a leader terminal. Each terminal connects to the portal so that it can send and receive data and commands between each of the plurality of terminals and the portal through the portal. The portal then connects to a server using a telecommunications connection. The server has the informational content resident thereon desired by the user and presents marketing messages (or other messages) to each of the users. The reactions of the users are recorded, with the recorded information used to identify when a leader of a group is also leading purchasing behavior for the group.

### BACKGROUND OF THE INVENTION

The present invention relates to the fields of communication among online users, Internet marketing and information distribution. More specifically, one embodiment of the invention provides an efficient communications portal for enabling a plurality of users to collectively access information from a network, in effect creating a shared experience.

A common distributed client-server network couples multiple resource objects (computers, etc) over a communications network. The distributed network invariably couples one or more servers to one or more clients, with each server and client having a unique address so that each can determine which network messages are directed to it. Such a system often involves one server providing the same information to many clients. In such systems, a server waits for a request from a client and then performs some service or disseminates some information in response to the client request. A client is an object that makes the request of the server.

The client-server architecture facilitates an almost infinitely scalable structure. However, as presently implemented by the Internet, World Wide Web and the like, client access to the information on a server remains a profoundly solitary experience from the perspective of the end user of a computer network. Individual clients access the content of the server individually with no shared interaction between or among them.

This top-down hierarchy of most distributed computer networks is ameliorated to the extent that the designation of a particular object (computer hardware and/or software process) as a “server” object or a “client” is not fixed. A given object can be a server for some services and a client of other services, thereby creating something of an interactive relationship between the user and the host. Nevertheless, at any given instant, the client-server relationship of a distributed computer network remains a feature of distributed computer networks. This provides a serious limitation in providing a shared experience among a plurality of users in that it facilitates only individual activity for each user.

A more recent development has been the advent of functionality allowing a given computer to function as both a client and a server at the same time. An example is so-called “instant messaging” which allows one computer to receive information from a server object while also serving information to another, client object (either the same object from which information was received or to a different object altogether). However, even in this architecture, the hierarchy of client and server remains—a given computer is one or the other for purposes of performing a given function.

Having multiple client objects access a common server collectively is usually limited by the bandwidth of the communications network. True simultaneous multi-client server access could be bandwidth limited, but this does not usually matter since client-server communications need not happen all at one time, in real time, and further that network traffic is much less than the network capacity. As used herein, the term “Internet” refers to the global inter-network of networks that communicates primarily using packets sent according to TCP/IP (Transport Control Protocol/Internet Protocol) standards well known in the art of computer intercommunication. The Internet's extent is not known or fixed, so messages to all users must be sent as separate messages to each user seeking to receive the information.

Problems arise for multiple client objects communicating with each other in real-time through a server. For example, high-bandwidth data such as audio streams, graphic images and image streams sent from one server amount to broadcasting to a plurality of receivers. One application of such a client-server system is for game playing, where the positions and actions of each user need to be communicated between all the players to inform each client of the state changes (position, actions, etc.) which occurred at the other clients. The server might maintain global state information and serve as a data server for the clients as they request visual, program and other data as the game progresses.

A variant of game playing uses a peer-to-peer architecture in which a client keeps a copy of the data that is common to all clients so that only information passed between clients is broadcast over the network. Such an architecture has limitations: for example, the number of messages passing between clients is on the order of the square of the number of clients, so the number of game players is limited to the message handling capacity of the architecture. Whereas, true broadcasting would have one message sent for all clients to listen to; not all networks allow for it, so broadcast between the players is handled by generating one message to each player client in a style similar to instant messaging, but subject to the aforementioned bandwidth limitations.

Internet game playing, as well as related “chat” rooms, have the advantage of allowing multiple users to interact with each other while sharing some data in common as well as the shared common experience that comes with it. One such example can be found in U.S. Pat. No. 6,219,045 to Leahy et al. Nevertheless, game playing remains a solitary activity indicative of the classic client-server architecture: each player of a game pursues a solitary experience based on information supplied by the server. The game experience of any one player is unique to that individual. Indeed, game playing makes a virtue of the solitary nature of on line activity by pitting one player against another. The extent of common experience is generally limited to predetermined information supplied by the game and does not extend to the interactions of the any one player of the game being shared with any other player. More tellingly, the presentation of the games predetermined information does not extend beyond the particular game being played; the simple act of changing from one game to another necessarily involves downloading the shared information from a common server, which is exactly the structure of conventional broadcasting or web surfing.

A problem in the industry has been that a truly interactive shared experience on the Internet would require downloading enough information to create a shared experience of the sort achieved by conventional broadcasting, which has not been technically feasible. However, going beyond the predetermined limits of shared downloaded information (e.g., a game) raises the additional potential of allowing the Internet to become a shared experience. To date, no solution has emerged to allow multiple clients to access the resources of one or more servers in substantially the same time and manner so as to create a shared experience among a plurality of users. Furthermore, no solution has emerged to do this without requiring additional software downloads while also being fully implemented on the Internet or World Wide Web. In the present invention, all modifications to the core engines, components, users' interfaces, as well as the incorporation of new features are added to servers and automatically become available to the users without the need for further software downloads. This ability, termed extensibility, supports portability of the shared experience. The ability to engage in the shared experience no longer depends on access to any single computer or terminal. By using common OEM software, the present invention can be made available on virtually all web enabled computer devices, thus further increasing the potential of the interactive shared experience.

One way of overcoming the problem referenced above is exemplified in U.S. Pat. No. 6,323,857 to Mielekamp, et al who proposes to offer a visual impression of a virtual space on his or her terminal in which the user is embodied by an avatar which is visually reproduced as a sprite, i.e. as a predetermined pixel pattern. This patent describes how the user can control the location of his or her avatar in the virtual space so that users can act as if they are present in the virtual space and hence can interact with other users. The patent notes that selectively establishing contact on the basis of an observable impression of the virtual world is attractive to users. The virtual space offers the users a metaphor, which stimulates social contacts. Mielekamp, et al propose linking a number of terminals together with a broadcast signal principally to stimulate interaction between and among different users as well as others who are not represented by avatars in the virtual space.

Another problem faced in the art pertains to online marketing. The advent of the Internet, World Wide Web and the like has opened the possibility of providing advertisements that while tailored to the interests of particular users, can be distributed to an enormous population of persons. It has long been known that individual attributes can be used to anticipate preferences and interests for individual consumers. However, knowing which individual attribute or set of attributes can be used to anticipate an interest in a particular brand of product or service is an extraordinary difficult task. Many individual attributes exist, such as sex, age, income, etc., and the potential combination of attributes increases very rabidly (by a factorial). Many of these attributes and combinations of attributes are completely irrelevant for selling any particular product or service. Indeed, the effectiveness of any particular advertising campaign today often requires using the services of a marketing company that analyzes and interprets large amounts of data to help define which attributes are relevant and should be considered for the development of an advertising campaign. This analysis is quite expensive, and takes a long time to complete. Moreover, relying on marketing research firms for online marketing negates much of the hope for improved productivity and efficiency from using online marketing in the first place. A need exists to identify, quickly and simply, the relevant attributes of consumers that attract them to a particular promotion of a brand of product or service.

A further interest of marketers lies in identifying patterns of “viral marketing”, which is a term of art in the advertising industry for sales directed by consumers who promote a brand of product or service to their friends or peers (the idea is that one consumer tells a second consumer about a brand, who in turn tells a third, etc., so that the recommendation of the brand propagates among consumers like a virus.) It is well known in the marketing industry that word of mouth, or viral marketing, is the most effective form of advertising. When considering the Internet's particular capacities, marketers understand that viral marketing can provide a most effective advertising boost. Yet the question of how to harness and control viral marketing has not been solved and as such the advertising messages that set off a chain of viral marketing are the most difficult to measure using conventional market research approaches.

A final marketing concept is that of the effects of peer pressure, or group influence, on sales. It is well known that individuals will more willingly purchase products when they are part of a peer group than they will when alone. The effect seems to rely on the belief in the superiority of the judgment formed from a consensus that combines the experience of several individuals. Each member of the group will then believe that the purchase of a particular brand of product or service is the correct action to take. Groups of consumers who achieve consensus are much more likely to make a purchase than are individuals who are acting alone. Online marketing has the ability to bring together groups of individuals. However, the present solitary experience provided consumers online does not make any use of the inherent advantages of group purchasing behavior.

It is necessary to reconfigure the structure of the online experience to realize the advantages of group purchasing behavior and to track viral marketing since existing systems and methods for online activity are not capable of realizing the full potential of the online purchasing experience.

### SUMMARY OF THE INVENTION

The present invention provides a method for enabling a plurality of computer users to interact via a set of interconnected terminals (keyboard pulse monitor, or possibly a mobile device with a display screen and a data entry capability). A plurality of terminals, each having a user interface, connect to a server or network such as the Internet or World Wide Web through a portal rather than directly to the server. Each terminal is connected to the portal. One terminal serves as a leader terminal. Each terminal has an interface that provides access to the terminal from at least one user per terminal. Each terminal connects to the portal so that it can send and receive data and commands between each of the plurality of terminals and external server through the portal. The portal then connects to a server using a telecommunications connection such as the Internet or World Wide Web. The server has the informational content resident thereon desired by the user. Data is sent and received between the server and the portal over the telecommunications connection in much the same way as, for example, a standard Internet connection. Each terminal accesses the informational content on the server through the portal under the control of the leader terminal. The content received through the portal is then displayed on the interface of each terminal.

Each of the terminals communicates with the portal through an avatar. This avatar, in addition to providing a visual representation of the user, also provides for navigation to and through the information content on the server (and associated network). This combination of avatar depiction and directional navigation ability is herein referred to as a Navetar. Each terminal has an interface that depicts a Navetar selected by a particular user.

The Navetars interact through the portal in one environment in the portal. The connection between each of the plurality of terminals and the portal control the actions, appearance and characteristics of the terminal's Navetar in a given portal environment.

A given portal environment can be divided into any number of rooms. Each room can have its own unique identity, including perhaps its own indicia of corporate sponsorship.

A sponsor, such as a corporate sponsor, web service company or any other interested party, can operate the portal. The sponsorship relies on a communications link for sending information to and receiving information from each terminal, the information sent from the portal sponsor including advertisements, and the information received from the terminal including indicia of consumer behavior. The interfaces on the users terminals can display information sent from the portal sponsor The information from the portal sponsor, including the advertisements, can include direct or indirect prompts for receiving marketing inputs from the user of the terminal. The marketing inputs from the terminals are then returned to the portal sponsor for use in marketing to the user of the terminal.

The marketing inputs are archived and then analyzed so as to generate a unique profile of the user. Bypassing the need to associate personally identifiable information (p.i.i.), demographic data, and routine questionnaire-type profile generation schemes, the proposed solution solely develops user-associated profiles by archiving and analyzing the data generated by the user's Navetar experience. This process of building up a profile from the explicit actions, emotions and navigation of the Navetar/user, is a core piece of what the invention terms Reverse Profiling.

The present invention has numerous advantages. The problem of broadcasting to numerous users is eliminated by having each of several users access content in the manner in which content is usually accessed in a distributed client-server relationship such as the Internet or World Wide Web. In what the invention terms fUSE and fUSEing, content is accessed by several users together, under the direction of a leader. The number of users accessing content is not so great as to present any meaningful bandwidth problems as could result from attempting to broadcast information.

Further, the insertion of a portal between the user and the content provider on the server (such as a web site provider) allows for a way to protect the privacy of individual users. Whereas content providers, such as web site operators, have no interest in preserving the privacy of individual web surfers, the portal provider has a keen interest in maintaining privacy to maintain the interests of users in using the portal. Furthermore, the portal provides for a form of collective access to information, such as collective web surfing, that the Internet and similar electronic communication networks, including conventional broadcast media, cannot provide to their users.

It is known in the art that collective action is particularly conducive to particular forms of desired social interactions. For example, group shopping is more likely to result in online purchases than are individual visits to a shopping web site (which often result in abandonment of a shopping cart prior to purchase). Groups are more apt to sample electronic media, and purchase individual records or movies, than are individuals who access the same information. Even in other fields, such as online learning, group activities such as study groups are more likely to result in more efficient learning activity by having the group visit an information site together than would be possible by having the same number of individuals each access the information individually.

Therefore, it is an objective of the present invention to increase individual privacy in online activities. It is an objective of the present invention to facilitate group interactions in an online communications system. It is an objective of the present invention to increase the efficiency of online commercial and educational activities.

It is also an objective of the present invention to support marketers in gaining a deeper insight into users' online behavior by observing the online users in a contextual framework that is structured to provide both an improved online experience for users and improved marketing experience for advertisers.

It is also an objective of the present invention to permit marketers to track viral marketing among individual Navetars, while also fully protecting the privacy of individual consumers.

In accordance with the present invention, there is provided a method enabling a plurality of computer users to communicate via a set of interconnected terminals that includes

each terminal having a user interface, with one of the terminals being a leader terminal, the interface providing access to the terminal from at least one user per terminal;

connecting each of the plurality of terminals to a portal;

sending and receiving data and commands between each of the plurality of terminals and the portal through the portal;

connecting the portal to a server using a telecommunications connection, the server having informational content resident thereon;

sending and receiving data and commands between the server and the portal over the telecommunications connection;

accessing the informational content on the server at each of the plurality of terminals through the portal, the access to

informational content at each of the plurality of terminals being controlled by commands supplied by the leader terminal; and

simultaneously displaying the informational content selected by the lead terminal at each of the interfaces for each of the plurality of terminals.

Further in accordance with the present invention, there is provided a method of online advertising, comprising

creating a portal for receiving online connections from a plurality of users;

creating one or more room environments accessible from the portal, the room environments being able to display a plurality of messages to individual users through the portal

creating a plurality of navigational avatars (Navetars) within the environment, each of the Navetars having an individual profile;

creating an ad database containing one or more advertisements, promotions or media content; each advertisement, promotion or

media content having a profile associated with it, the ad database being connected to the portal

displaying the advertisement, promotion or media content from the ad database to the Navetar in the environment;

recording the response of the Navetar to the display of the advertisement, promotion or media content, and

changing the profile of the Navetar in response to the recorded response to the advertisement, promotion or media content.

Further in accordance with the present invention, there is provided a system for accessing information and for displaying advertisements, promotions or media content on line, comprising:

a browsing portal for accessing third party content by way of a distributed information access system, the browsing portal being interconnected to a plurality of users to the third party content,

a fuse module that can combine a plurality of individual users into a single fused directional avatar (Navetar) group

a room environment module that displays a plurality of different environments to the fused Navetar,

an advertising database that presents a plurality of messages to the fused Navetar in the environment, and

an online storage module for storing individual profiles of the individual Navetars which include their response to individual advertisements.

Further in accordance with the present invention, there is provided a method of viral marketing, comprising

creating a portal for receiving online connections from a plurality of users;

creating a room environment accessible from the portal, the room environment being able to display a plurality of advertising messages to individual users through the portal

creating a plurality of navigational avatars (Navetars) within the environment, each of the Navetars having an individual profile;

creating an ad database containing one or more messages, each message having a profile associated with it, the ad database being connected to the portal;

displaying the message from the ad database to the Navetar in the environment;

recording the response of the Navetar to the display of the message,

changing the profile of the Navetar in response to the recorded response to the message;

fusing a plurality of Navetars to form a fused Navetar group, the fused Navetar group having a profile comprised of the unique combination of its members' profiles, the fused Navetar group acting to receive the display of advertisements from the ad database, the fused Navetar group having a single Navetar acting as leader of the group of Navetars,

recording the response of the fused Navetar group to the display of advertisements,

recording the actions of the leader of the group of Navetars

changing the profile of the ads in the ad database in response to the response to the activity of the leader of the fused Navetar group.

All of these objectives, features, and advantages of the present invention, and more, are illustrated below in the drawings and in the detailed description that follows.

### BRIEF DESCRIPTION OF THE DRAWINGS

FIG. 1 shows a generalized view of a conventional client-server relationship in a way that is useful for understanding the present invention.

FIG. 2 shows a client-server relationship that has been modified in accordance with the present invention.

FIG. 3 shows the interface for a user first accessing the portal of the present invention and generating a unique user profile via the selection of icons and preferences.

FIG. 4 shows a plurality of Navetars interacting in an environment in the portal.

FIG. 5 shows the environment of FIG. 4 after the formation of a fUSED Navetar Group.

FIG. 6 shows a FUSED Navetar Group operating in other environments of the present invention.

FIG. 7 shows one of the possible ways to access content from a remote server using the present invention.

FIG. 8 shows the relationship between the Navetar, the Environment and the Ad profiles.

FIG. 9 is a conceptual illustration of the relationship of the browsing portal of the present invention to other features that are also part of the present invention.

### DETAILED DESCRIPTION

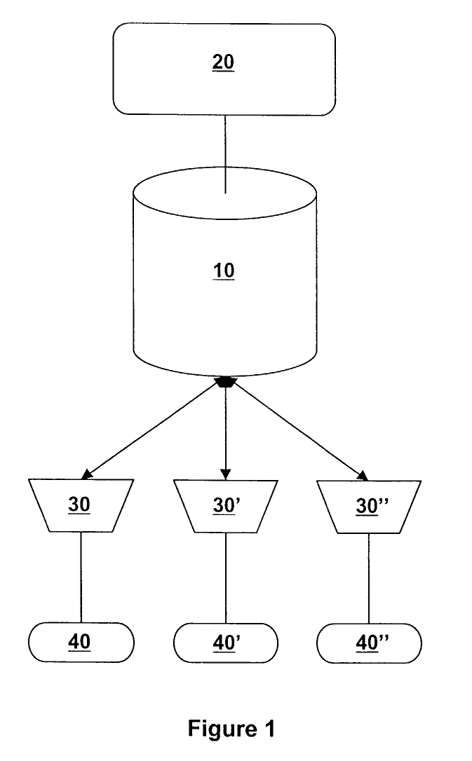

FIG. 1 shows a generalized view of conventional client-server relationship in a way that is useful for understanding the present invention. Content information resides on the server 10, of a type that is well known in the art. A sponsor 20 puts up the content on server 10 and maintains it there over time in ways that are well known in the art. A number of clients access terminals 30, 30′, 30″, etc., having browsers or other display interfaces of types that are well known in the art, access the content on server 10 and display it to a number of end users 40, 40′, 40″, etc., respectively.

As shown in FIG. 1, each end user 40, 40′, 40″, etc., has a different experience depending on the information that each chooses to download from the server 10. Each access terminal 30, 30, 30″ displays information from server 10 separately from each of the other access devices. Each user 40, 40′, 40″, etc. separately controls the information displayed by his or her respective access terminals 30, 30, 30″. Thus, each user experiences a uniquely solitary experience while interacting with the server.

It is to be appreciated that the designation of individual computers as terminals 30, 30′, 30″, etc, or the server 10, is somewhat arbitrary. Likewise, the designation of an entity as being a sponsor 20 or a user 40, 40′, 40″, is somewhat arbitrary. However, the relative relationship between the components as shown in FIG. 1 survives and as such changes designation, since the provision of content and its access remains a profoundly solitary experience. This is particularly significant given that the server 10, as depicted in FIG. 1, could include any number of interconnected computers such as provided by the Internet, World Wide Web, and similar networks.

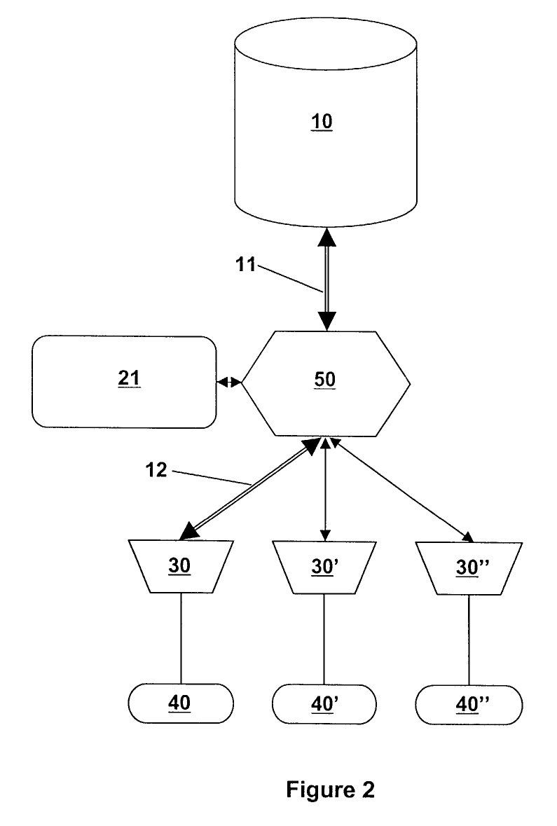

FIG. 2 shows a client-server relationship that has been modified in accordance with the present invention. The content resident on the server 10 remains as shown in FIG. 1, and can be provided by a sponsor (not shown in FIG. 2). However, FIG. 2 shows the addition of a browsing portal 50 that connects a number of terminals 30, 30′, 30″. The browsing portal 50, explained in detail below, facilitates the sharing of access among different users 40, 40′, 40″, etc. In effect, the browsing portal 50 provides the same data to each of the users so that each user shares, preferably in real time, the experience gained by access to the server 10.

As shown in FIG. 2, a portal sponsor 21 sponsors the browsing portal 50. The portal sponsor 21 maintains the shared access provided by browsing portal 50 to content provided by server 10. As described below, the portal sponsor 21 may also communicate with each user 40, 40′, 40″, etc., for a number of purposes, including presenting messages that include, but that are not limited to, advertisements, marketing messages, and promotional content. Portal sponsor 21 in FIG. 2 is representative of the various sponsors who would have access to the ‘relevant’ users 40, 40′, 40″. User ‘Relevancy’ is determined by the database of archived and analyzed profiles. Profiles are created for all users, environments and advertising content. When a match is made between a target user profile and an advertising content profile, the portal sponsor 21 will send the message content through browsing portal 50 to the user. Browsing portal 50 will then record the interaction between the delivered advertisement content and the user, which is then shared with portal sponsor 21. Only those profiles that match would be eligible for communication by portal sponsor 21.

All users using browsing portal 50 are included in a social experience where contextual environments and broadly targeted messages that include, but are not limited to, advertisements, promotions and content provide a shared experience. In these default instances, users can freely communicate with each other and travel within the environments of browsing portal 50, can surf the internet via browsing portal 50, can experiencing content from server 10 and advertisement content from portal sponsor 21.

As explained in detail below, a particular type of connection between and among the users using browsing portal 50 is referred to herein as a fUSED state. It is the fUSED state that allows a number of users to simultaneously use the browsing portal 50, while privately communicating amongst themselves and sharing information gained from content server 10 and portal sponsor 21. This fused state provides an even more robust shared experience.

As shown in FIG. 2, when in a fUSED state, one user selects the information from the server 10 for presentation to the group. As shown, a lead user 40 selects information from server 1O over a connection 11 using his lead connection 12 to the browsing portal 50. The browsing portal 50 then ensures that the information received from the server 10 over connection 11 is also presented to each of the other users 40′, 40″, etc, connected to the browsing portal 50.

Understanding the operation of the browsing portal 50 involves several aspects. First, the individual users 40 need to both access the browsing portal 50 and be accessed by other users and by the portal sponsor 21 via the browsing portal 50. A Navetar is a combination avatar and ‘navigation device’. In a one embodiment, a Navetar is a personalized icon that each user employs to have presence and characteristics within the browsing portal 50. A user can configure multiple specific characteristics of the Navetar's appearance using system-driven options. Also, a Navetar can express personal emotive attributes (emotions) such as ‘Happy’, ‘Sad’, ‘Angry’, ‘Mad’, ‘Smiles’, ‘Cheers’, etc. . . The Navetar is a creation of software programming that acts as a combination of a conventional avatar, many examples of which are well known in the art, and an on-line navigation device.

As contemplated by the present invention, the Navetar functions like a conventional avatar in providing an online visual representation of its user, a sort of character icon for the character of the user 40, 40′, 40″ etc. However, the Navetar goes beyond a conventional avatar in two distinct ways.

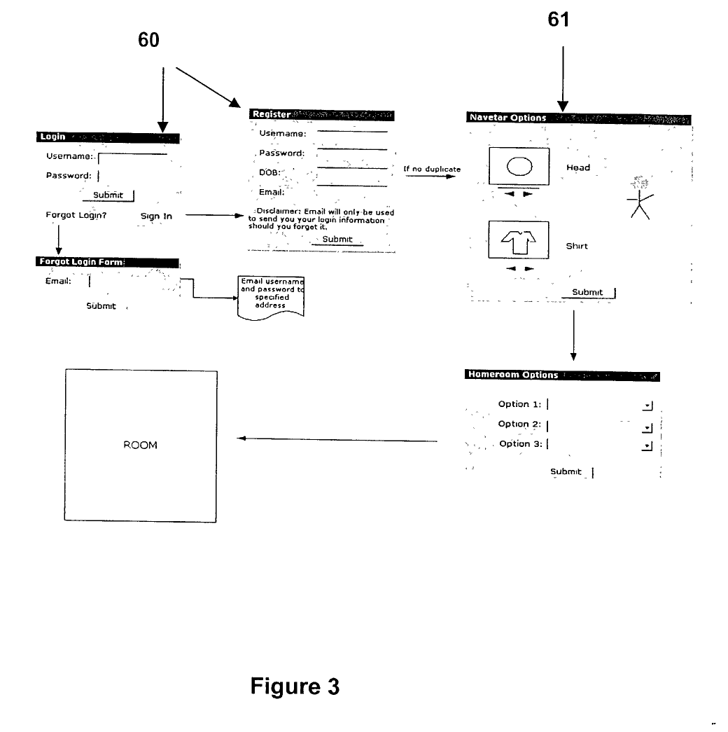

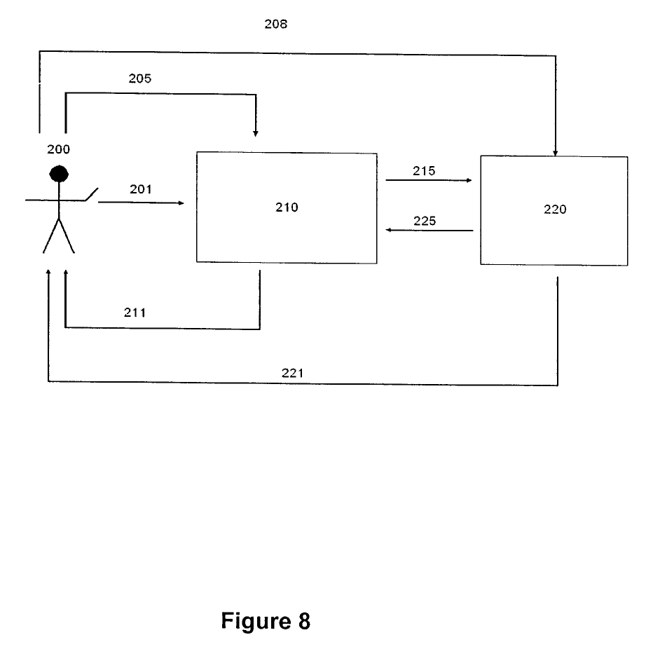

One way is to have the Navetar function as the online embodiment of a user's identity. The identity profile is first compiled at the generation of a Navetar 61 as depicted in FIG. 3. The profile is then continuously modified by the user's manipulation of the Navetar in its interaction with browsing portal 50, sponsor portal 21, content portal 10 and other users' Navetars as shown in FIG. 8 and explained in detail below. The Navetar is fully customizable at all times. The browsing portal 50 will maintain a dynamic database that records Navetar activity and its modification of the related user's profile. This database can further be used to observe and report on similar profile characteristics across Navetars/user profiles.

The second way in which a Navetar differs from a conventional avatar is in the Navetar being a navigation device that can include a variety of informational aspects such as information found in, for example, a Friends list, the present inventions proprietary ‘buddy list feature’, ‘Go to’ features, a URL address, and can have the ability to send and receive instant messages. As contemplated, the Navetar has the ability to initiate a fUSED state with other Navetars in the browsing portal 50 so as to create a shared browsing experience for content from server 10. Again, unlike a conventional avatar, the Navetar of the present invention can respond to requests from other users to initiate a fUSED state, as well as to display a variety of other pieces of information such as may be ascribed to emotion on the part of the user. Based on these initial and ongoing factors, the Navetar can represent a unique profile of a virtual individual. The Navetar, via its profile, can thus be used to locate and draw relevant advertisements, promotional messages and marketing content from the portal sponsor 21 and/or content from the server 10 to a given user.

The Navetar, being a software creation resident on the browsing portal 50, corresponds to no attributes of any user 40, 40′, 40″ that the user has not chosen to ascribe to the Navetar. Hence, the attributes ascribed to a particular Navetar need not be correlated to any individual in the real world, which should help to ameliorate concerns relating to individual privacy for online marketing. In effect, the task of preserving individual privacy has been transferred to both, the browsing portal 50 and the portal sponsor 21, from the content sponsor 20. This is believed to be a particularly advantageous feature, since a content sponsor 20 would have no economic interest in maintaining the privacy of individual users 40, 40′, 40″, whereas a portal sponsor 21 would have an economic interest in maintaining privacy as a way of encouraging use of the browsing portal 50 via the users' terminals 30, 30′, 30″ and thus cultivating a relationship with these users.

Navetars are the vehicles by which the browsing portal 50 interacts with outside content, represented as being resident generally on the server 10. Navetars should appear as primary subjects in content where possible and appropriate.

Further, the Navetar representation on browsing portal 50 can receive advertisements and promotions that are relevant to a behavior profile of that individual Navetar. As contemplated, the Navetar can have the ability to allow its corresponding user to simply send away any ad or promotional message that is not desired. Likewise, changes to image, surfing habits and online activities can be recorded by the browsing portal 50 and the portal sponsor 21 and updated over time so as to evolve a profile of the individual user over time (Reverse Profiling). In effect, the individual Navetar representation on browsing portal 50 for individual users 40, 40′, 40″ etc. allows each user to control his or her own web experience even while engaging in collective information access activities.

The browsing portal 50 provides an environment in which individual Navetars can interact. The environment is an online virtual space that displays content and advertisements in context as well as the Navetars. The environment provides Navetars with a sense of location and space where they can interact with each other, experience advertisements and media content and use their communications functions. The environment is designed with perspective and space limitations and has the ability to allow a media-player to show content. The environment itself has a profile that is altered by the profiles of the Navetars that enter it as well as the advertisements that are pulled in by its own profile and the combined Navetar profiles.

As contemplated by the present invention, Navetars are clickable for interaction, so that a user can engage another Navetar within a given environment by clicking on it. Clicking on another Navetar launches a process to have the Navetar added to a Friends List or to initiate a fUSE request. Navetars appear in all environments. All Navetars that are not fUSED can appear in an environment, whereas fUSED Navetars may or may not be visible in environments to Navetars not included in the particular fUSEd group, and generally would not appear for privacy reasons. Navetar actions and characteristics generate profile histories (Reverse Profiling).

The environment created on browsing portal 50 can receive the indicia of corporate or commercial sponsorship, e.g., advertisements, promotions, offers, commercial endorsements, etc., as well as other indicia tending toward creating a themed environment. Such a theme environment simulates a real-life space while also providing a context for advertising content. Context here means the relationships between advertisements, branding and themed rooms that support the environment and each other. The environment can also take on a visual representation of a location in real life with perspective.

A given environment will include a number of rooms, in which each room is a virtual place within an environment. Each room can have a unique title and distinct characteristics. The rooms are the specific place where interactions occur and where objects, other Navetars, and content can be experienced. Additionally, a room displays a depth of field that allows a user to move closer or farther away from objects and walk past other Navetars. A room can have a commercial sponsor in a vendor relationship. A room can have a 3 dimensional feel and display depth of field.

As users must be able to visually identify other Navetars and fUSED groups within a room, it may be necessary to limit attendance in a room for visual constraints, such as between 1 and 50 Navetars or fUSED groups, with any additional visitors being directed to an empty room. A Guest log can retain all names of Navetars in all the versions of the room. However, when Navetars fUSE, they are transported to a ‘close-up’ view that is ‘within’ the room where they are fUSED.

The fUSED group focuses on social browsing, or navigating the content of a site or the Internet in general as a group. A fUSED Navetar exists as a single entity within an environment of browsing portal 50 and becomes the character for interaction with individual Navetars or fUSED Navetars within a Room. Environments provide closed, private chat options, when Navetars are engaged in a fUSE.

FIG. 2 depicts such a fUSED group of two or more users. The fUSED group may browse within an environment created in browsing portal 50, or may leave the portal environment (i.e. browse the World Wide Web through browsing portal 50) to access content directly from an external server 10. All Navetars and fUSED Groups will remain anonymous to the external server 10 which will only register that a generic browsing portal 50 is interacting with it. This further enhances the potential of browsing portal 50 and portal sponsor 21 to be the only ones with full understanding of the user profiles that further provide incentive to them to maintain the users' privacy. It is important to realize that a fUSED Navetar Group will exist only with two or more users, and that the fUSED Navetar Group acts exactly as a single user for purposes of accessing the server 10. Further, a fUSED Navetar Group can have one and only one user as the leader. Likewise, a user can be in one and only one fUSED Navetar Group at a time, and a given user cannot be both a leader and a follower at the same time. However, the role of the leader of a group of fUSED Navetars may change at any time.

The leader of a fUSED Navetar Group will determine the actions of the fUSED Navetar Group. Such an action can include determining a URL to be pulled by all other fUSED users. While fUSED, the Navetars can see each other, communicate fully and have the full range of emotions available to them at all times so as to generate psychographic data for marketing purposes of the browsing portal 50 and portal sponsor 21.

A user may defUSE at any time, leaving the rest of the group fused. A leader of a fUSED Group can defuse via the delegation of leadership to another member of the fUSED Group.

As contemplated by the present invention, the browsing portal 50 allows for Communications between and among individual users 40, 40′, 40″ etc. as well as with the portal sponsor 21. The communications capabilities provided by browsing portal 50 can include a Friends List, which is a customizable list assigned to each users' Navetar. As with traditional buddy lists, this Friends list contains the names of a select group of other users & Navetars, chosen by the user, and provide an indication of whether a given user is online or not. The portal can allow a user to click on a name in the Friends list to establish an instant message (IM) conversation with the selected user; can choose to ‘go to’ the user/Navetar and join them in whichever environment they are located; can chose to leave them a short message (ESP) for them to read at a later time; or can initiate a request to fUSE. The browsing portal 50 will also provide for an ‘Email Sensory Program’ (ESP) that can serve as a short-message system which allows for Navetars to send short-bursts of text to each other and to non-Navetar users in lieu of a direct IM conversation or chat session. ESP messages can be delivered directly to a Navetar if the user is online, or will be saved until the user logs in and activates their Navetar at which point the ESP is delivered directly to the Navetar. The present invention will also allow for the IM application to communicate with other IM platforms (i.e. be interoperable) as well as mobile and wireless devices.

A Navetar may fUSE to a group of fUSED Navetars that is already formed, but only when invited to by the group. The fUSED groups must be protected in their privacy—allowing other Navetars to interrupt the fused group's dynamic would be counterproductive. Hence, a Navetar that is not a part of the fUSED group will not see the fUSED group—they will only know through the Guest Book interface that the Navetar being searched for is within the same room and can be reached via ESP. A non-fUSED Navetar would normally be invited to fUSE.

Users of browsing portal 50 can communicate with each other in real time using a chat feature. The real time chat interface is built into the environment navigation and available to a person on every page. Within any chat, a person chats under their Navetar name.

The browsing portal 50 provides an audience for any user. The audience is the collection of other persons who can presently receive and send communications to the user's Navetar. A user's Navetar has only one audience at any time, but if they are part of a fUSED group, then everyone in their fUSED group is part of their audience. A user can send or receive a message from anyone in the same environment or room (via chat and IM). A user can send or receive a message from anyone in another environment or room (via esp). A user can send or receive an esp at any time, from any location and within any location. A user can send and receive a message via IM to another IM platform both inside and outside of portal 50.

A user may use the following three communication modes:

| Method | Name | Audience |
|---|---|---|
| Chat within a | Chat | Any/All Navetars |
| room | | in a ROOM (many |
| | | to many) |
| Chat within a | IM | Only members of |
| fUSED Navetar | | fUSED groups |
| Group | | (few to few) |
| ESP - short | ESP | Individual |
| messaging/light | | NAVETAR/ |
| email | | PERSON (one to |
| | | one) |

Communication will be in the form of a text-based message displayed in real time, or IM, potentially supporting html tags and/or gifs, voice to voice communication, or video to video (face to face) chat.

Relative to the users 40, 40′, 40″, the browsing portal 50 can act in a way analogous to a home page. The portal can provide a fully customizable and personalized start page, or Homeroom, which is the first environment that a user experiences at the portal. Prior to entering the Homeroom (start page) the present invention provides a process for a new user to acquire, design and personalize a Navetar. At any time, the user can change characteristics of the Navetar's appearance using portal-driven options, further driving the Reverse Profiling process. For example, the user can specify their Navetar's shirt, trousers, skin tone, hair color, gender, etc. The number of customizable characteristics as well as the number of available choices per characteristic can vary. A user may also revisit the Homeroom and change any number of aspects, at any time.

The browsing portal 50 can also maintain an Ad Delivery system supported by the portal sponsor 21. The ad delivery system can respond to indicia of consumer behavior, both past and anticipated behavior. This objective can be most easily achieved using a database of profiles for individual Navetars, both for those of individual users as well as for fUSED Navetars, as well as for Environments. It is also possible to track the reception of individual advertisements. The Ad Delivery system can match the profiles of advertisements in the database with the profiles of potential destinations, Navetars, fUSED Navetar Groups and environments. The profile of an ad that is pulled to a Navetar or fUSED Navetar Groups through keywords, product interaction and/or web surfing behavior will adjust and self-assess to match the new profiles. The Ad Delivery System manages how the ads are taken from the database and sent to Navetars and environments, and the management of the information on how the ad was received.

As shown in FIG. 8, the self-maintained ad engine model bases user profiles, room profiles, environment profiles, and advertisement content profiles on categories so that any interaction between a user and a room will trigger an adjustment to both the user profile and the room profile. Similarly, any interaction between a user and advertisement content will trigger an adjustment to both the user profile and the ad profile. This model results in user profiles, room profiles, environment profiles and advertisement content profiles that change dynamically over time.

FIG. 3 shows the interface for a user first accessing the browsing portal 50. As shown, the user first logs into the portal at 60 and then creates a personal Navetar and Homeroom at 61. The user can then proceed into the portal.

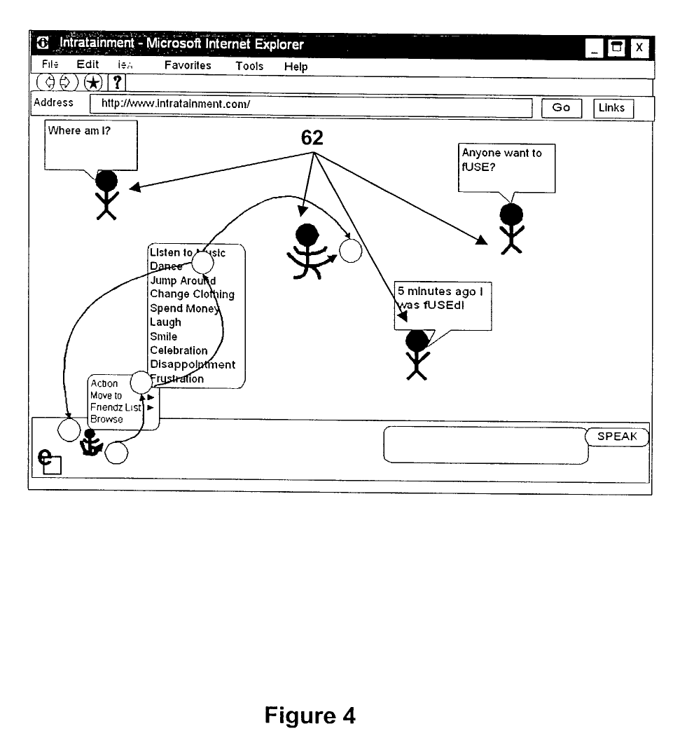

FIG. 4 shows a single Navetar 62 interacting with other Navetars in an environment in the browsing portal 50 prior to the formation of a fUSED Navetar group.

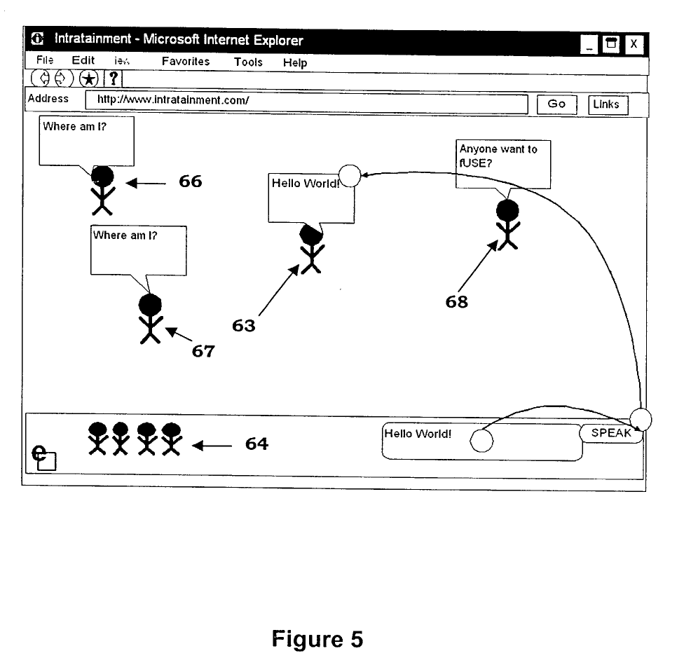

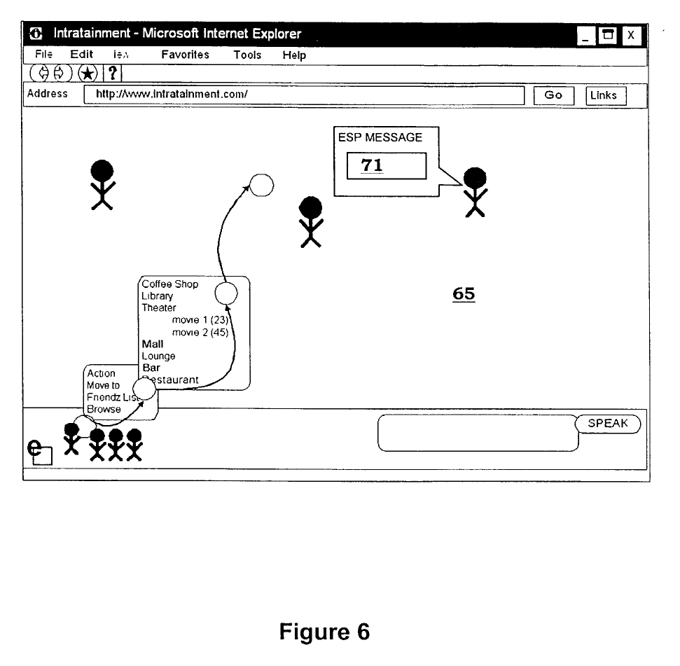

FIG. 5 shows the environment of FIG. 4 after the formation of a fUSED Navetar Group 64. The fUSED Navetar Group 64 is made up of the plurality of Navetars 63, 66, 67 and 68; also shown in FIG. 4. The fUSED Navetar Group 64 can collectively navigate to other environments, 65, within browsing portal 50 as shown in FIG. 6. Through the fUSED Navetar Group 64, the users represented by each of the plurality of Navetars 63, 66, 67 and 68 can now collectively and simultaneously access content 70 from a server 10 (FIG. 2) through frame 69.

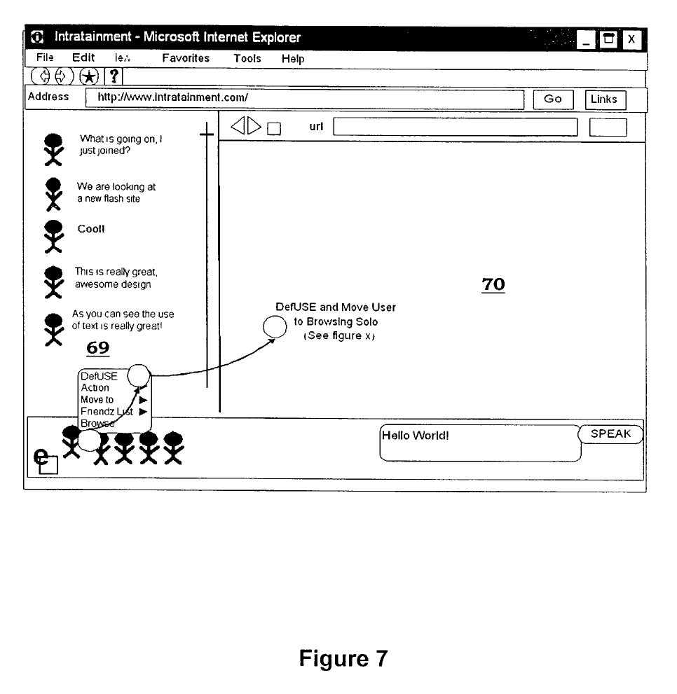

The users comprising the fUSED Navetar Group 64 can communicate with each other in any of the ways previously mentioned. One form of communication within a fUSED Navetar Group is that shown in FIG. 7. FIG. 7 shows such a chat session in frame 69 contemplating the content 70. Alternately, or in addition, communication can occur by way of a pop-up window 71 shown in FIG. 6, which such as found in a conventional instant message format and which would be especially useful in the present invention as a short message format, refered to as an ESP Message in the invention. Alternately, separated frames could be used to distinguish the different participants in a chat session.

It is to be understood that there are a wide variety of ways in which to implement the present invention. For example, framing the fUSED Navetar interactions can easily be replaced by an instant message format in which all chat within a fUSED Navetar occurs within the instant message window rather than in a separate, fixed frame. The instant message format may be somewhat more desirable in so far as it leaves more of the viewing window unobstructed, as well as being more flexible in allowing individual users a greater degree of flexibility and personal choice in controlling the presentation of information during a group browse session.

The portal 50 can be implemented using a Windows 2000 SQL Server with Windows IIS 5.0, Macromedia Jrun. The software code needed to implement the portal 50 can operate on any suitble platform. It is considered necessary to have a relatively robust messaging service such as that provided by an open source, XML (eXtensible Markup Language) based service named Jabber. The Jabber server supports interoperability with other messaging services, namely AIM, MSN, YAHOO, and ICQ.

The portal 50 also can be implemented using client-side software to support the graphical requirements of the site such as Macromedia Flash. Flash 5.0 contains native support for XML based data transfer that allows for relatively easy integration with the XML based messaging. Flash also supports distributed server architecture with, together with its programming language ActionScript can perform business logic on the client machine and can communicate to any number of servers located remotely. Middle ware can be provided, consistent with emerging industry standards, using JSP (Java Server Pages) as the server-side programming language.

FIG. 8 shows the interaction that the Navetar, Environment and Ad profiles have on each other. A users' Navetar 200 profile is already defined when it interacts, 201, with environment such as room 210. The room (210) also has a profile that has either been pre-determined by sponsors of the room or, alternately, through an ongoing process of profile evolution. However established, the room 210 has a unique profile that can be used to suggest what type of user will visit the room.

The act of visiting the room, 201, changes the Navetar's profile depending on the interaction with the room 210. This is depicted by 211. The room's profile changes based on the interaction as shown with arrow 205. The exact change in profile depends on the exact interaction of the Navetar 200 with the room 210.

As contemplated by the present invention, the Navetar 200 is exposed to advertising, marketing and entertainment content 225 from advertisement database 220 while in the room 210. The content 225 that is served to the room 210 to interact with the Navetar 200 also has a profile. The profiles of Navetars 200, environments 210 and the content of an ad database 220 are all established to match-target each other, so that each can subsequently impact upon each others' own profile.

The present invention contemplates an instance in which the environment 210 receives corporate sponsorship. In such an environment, the process for selecting an ad from ad database 220 by which the Ad 220 will be sent to the Environment 210 is pre-determined by the Environment sponsor who will only permit Ads that support the sponsorship motives. In these cases, an ad from ad database 220 is sent by interconnection 225 to the environment 210 regardless of the profiles of the Navetars in the environment. However, the response of the Navetars 200 to the ad is recorded and transmitted by interconnection 215 back to ad database 220. The responses can then be used to update the profile of the Navetar with information that can be used to change the ads sent to the environment 220, thereby allowing the marketer to gain insight into the relationship between the brand being advertised and the consumers using the environment.

The present invention also contemplates the instance in which the environment 220 is not sponsored. In this instance, the process for selecting among different ads in the ad database 220 will depend on the individual profile of the Navetar 200. The ad database 220 selects an ad that it deems most appropriate for a Navetar having the specified profile and delivers it by interconnection 221 to the Navetar. The Navetar's interaction with the Ad is then recorded and may also be transmitted back to the ad database 220 by interconnection 208 so as to impact upon the ad's profile. Thus, by recording and measuring the interaction between Navetar and ad, together with information regarding the context in which the interaction took place, the marketer can receive information about the relationship between the brand being advertised and the consumers comprising the Navetar.

Furthermore, fused Navetars can have their own recorded profiles. The profiles of individual Navetars can be updated to reflect the activities of the Navetar when it is part of a fused Navetar. This information is particularly important for purposes of tracking viral marketing, since the activities of individuals in a fused Navetar will indicate which individual Navetar corresponds to an individual who is a decision maker for consumers. It is well known that certain individuals in a group setting will assume leadership of the group. Determining who these leaders are is an important first step to determining the preferences and responses of those who carry out the majority of viral marketing activity. Furthermore, the ability to track the activities of fused Navetars will provide a way to measure the spread of viral marketing activity in response to online marketing activity provided through ad server 220. The ability to update the profile for an individual advertisement to capture group responses is thought to be an important advantage of the present invention.

It is to be appreciated that the present invention can be expanded to include any number of environments, each of which is designed to evoke real-world venues and situations, whereby users, via their Navetars, can interact with online entertainment and marketing offerings. The users' Navetar functions as an online persona in contextual environments while also encouraging interaction with the online offerings. The users will provide honest reactions and marketing insight that can be tracked and studied on the fly since the virtual identity of the Navetar provides a screen which eliminates the need for deception or avoidance of direct and honest responses to offerings.

For example, a sports shoe company can sponsor a sport-content room environment where many Navetars can congregate and enjoy the various sport content being offered. By commenting upon the ad & entertainment content, selecting favorites, fUSEing and taking the experience further, these Navetars provide the sport shoe company with true insight into the preferences of their target market and current consumers.

In the present invention, the environments are the hosts to the interaction amongst users and ad/entertainment content. By orchestrating these interactions to occur in a known and understood context, the present invention provides the basis for factual understanding and measurement of the interactions themselves, as well as providing insight into the meaning of decisions made by the Navetars.

The interactions between consumers and advertisements provided by the present invention will have value to marketers as a way of easily understanding data, as well as providing easy to use tools with which to engage the data. At present, marketers must rely on surveys of ad campaign efficiency that are conducted weeks or months after the commencement of the campaign. The survey data is itself difficult to properly understand even once it does become available. The delay in generating feedback data, as well as in understanding it, means that the data us usually useful only in launching the next campaign, and not useful to the present campaign.

In contrast, the present invention allows marketers to observe, and even quantify, viral marketing by providing an interface whereby the marketer can review the data that has been captured on each Navetar or any grouping of Navetars (clusters) in real time. The marketer thus has the capability to personally, without the cost or delay of an outside agency, analyze the data in any combination needed to further understanding of the target market, such as which ads consumers prefer, who the opinion makers are and their activities, group behavior vs. solo behavior with regards to brands in question, frequency of interaction with brands, rapidness of response to marketing messages, etc.

The present invention allows for successfully practicing the most basic tenets of brand marketing and advertising. With the present invention, it is possible to act upon the assumption that the customer is always correct and to listen and learn from the customer. The present invention allows for successful proactive marketing by staying abreast of current trends. It is well known that consumers are very open to advertising when it is relevant to them; they object most to excess advertising that is of no interest to them. With the present invention, irrelevant ads can be identified and deleted from the ad database, thereby empowering the marketer to be in full control of the marketing campaign by providing the marketer with the tools to conduct solid marketing and advertising. For example, the present invention captures the Navetars' relevant behavior and preferences. The marketer will learn what the consumers think and want by analyzing the Navetars' profiles. Studying the leadership of opinion makers and the viral marketing they engender will enable marketers to stay on top of the latest consumer trends and to design marketing campaigns that will execute at the proper time to achieve maximum impact. From the perspective of consumers, they, via their Navetars, will only receive relevant advertising as measured against the Navetar profile. The Navetar remains in control of which advertising it encounters and always has the option to reject the advert/content and send it away.

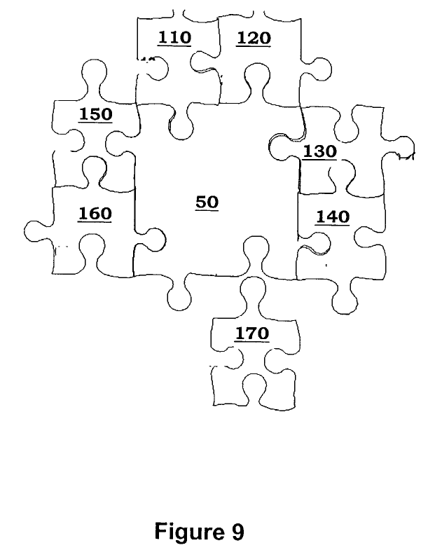

FIG. 9 shows a conceptual illustration of the relationship of the browsing portal of the present invention to other features that are also part of the present invention. The browsing portal 50 is the centerpiece of the architecture, in effect serving as the communications engine which facilitates the interaction amongst browsing portal 50, sponsor portal 21, content portal 10, modular components 110 through 170, terminals and users. Integral with it is the ability to fUSE individual Navetars 120 in fUSE module 110. Different room environments 130, as well as administration, reporting and user interface tools 140 show another aspect of the present invention. The ad delivery system 150 includes the advertisement database 220 shown in FIG. 8 which stores both advertisements and profiles reflecting responses to the advertisements from fused and/or individual Navetars. Profiling component 160 accommodates the individual profiles of the individual Navetars, group profiles of fused Navetars, room profiles, among other data storage functions. Additional applications, such as online storage of media content, can be added to the portal 50 as shown by piece 170. It is to be appreciated that each piece of the invention can be implemented separately in combination with portal 50 or in any combination desired for a particular application.

The principles, preferred embodiments and modes of operation of the present invention have been set forth in the foregoing specification. This specification, including examples, should be interpreted as illustrating the present invention and not as restricting it. The foregoing disclosure is not intended to limit the range of equivalents available to a person of ordinary skill in the art in any way, but rather to expand the range of equivalents in ways not previously thought of. Numerous variations and changes can be made to the foregoing illustrative embodiments without departing from the scope and spirit of the present invention as set forth in the appended claims.

What is claimed is:

1. A method of viral marketing, comprising
creating a portal for receiving online connections from a plurality of users;
creating a room environment accessible from the portal, the room environment being able to display a plurality of advertising messages to individual users through the portal
creating a plurality of navigational avatars (Navetars) within the environment, each of the Navetars having an individual profile;
creating an ad database containing one or more messages, each message having a profile associated with it, the ad database being connected to the portal;
displaying the message from the ad database to the Navetar in the environment;
recording the response of the Navetar to the display of the message,
changing the profile of the Navetar in response to the recorded response to the message;
fusing a plurality of Navetars to form a fused Navetar group, the fused Navetar group having a profile comprised of the unique combination of its members' profiles, the fused Navetar group acting to receive the display of advertisements from the ad database, the fused Navetar group having a single Navetar acting as leader of the group of Navetars,
recording the response of the fused Navetar group to the display of advertisements,
recording the actions of the leader of the group of Navetars
changing the profile of the ads in the ad database in response to the response to the activity of the leader of the fused Navetar group.
